(19) United States
(12) Patent Application Publication
(10) Pub. No.: US 2021/0385204 A1
(43) Pub. Date: Dec. 9, 2021

(54) ACOUSTIC SIGNAL-BASED AUTHENTICATION TO A CONTENT DELIVERY PLATFORM

(71) Applicant: T-Mobile USA, Inc., Bellevue, WA (US)

(72) Inventor: Kanakrai Chauhan, Snoqualmie, WA (US)

(21) Appl. No.: 16/897,172

(22) Filed: Jun. 9, 2020

(51) Int. Cl. H04L 29/06; G06Q 20/12; G06Q 30/06; G06Q 30/00; H04B 11/00

(52) U.S. Cl. CPC H04L 63/083; H04L 63/102; G06Q 20/127; H04B 11/00; G06Q 30/0607; G06Q 30/0185; G06Q 20/1235

(57) ABSTRACT

Acoustic data in an acoustic signal broadcasted by a subscriber device is received at a content presentation device. The acoustic data may include an authentication token that is generated by a content delivery platform for authenticating the content presentation device to the content delivery platform and content privilege information for a content consumer. The authentication token and the content privilege information are decoded from the acoustic data. A validation request that includes the authentication token is transmitted by the content presentation device to the content delivery platform to authenticate the content presentation device to the content delivery platform. In response to the content presentation device being authenticated by the content delivery platform, the content privilege information is transmitted by the content presentation device to the content delivery platform to obtain access to at least one category of multiple categories of program content segments from the content delivery platform.

### BACKGROUND

Media streaming services have become ever more popular with consumers. Consumers may watch streamed program content on non-portable large screen user devices such as smart television sets. Consumers may also watch streamed program content on portable user devices, such as smartphones, laptop computers, and tablet computers. The streamed program content may include live content that is delivered in real-time by a content delivery platform, as well as pre-produced media content that may be streamed on-demand from the content delivery platform upon the requests of consumers. A consumer may establish a user account and pay a recurring subscription fee for the streaming of program content from the content delivery platform. As such, the consumer is generally required to submit authentication credentials associated with the user account to the content delivery platform prior to being authorized by the platform to consume the program content on a user device. While consumers are able to watch streamed program content on their portable user devices while traveling away from home, consumers generally prefer to watch the streamed program content on non-portable large screen user devices whenever possible for a more immersive and enjoyable content consumption experience. For example, the non-portable large screen user device may be located in a hotel room, a vacation rental, or some other temporary lodging used by a consumer.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture that uses an acoustic signal to deliver an authentication token to a content presentation device that is able to use the authentication token to access program content from a content delivery platform.

FIG. 2 is a block diagram showing various components of a subscriber device that is configured to deliver the authentication token and content privilege information to the content presentation device via an acoustic signal.

FIG. 3 is a block diagram showing various components of the content presentation device that interfaces with the subscriber device and the content delivery platform.

FIG. 4 is a block diagram showing various components of the content delivery platform that uses the authentication token and the content privilege information encapsulated in the acoustic signal to provide the content presentation device with access to program content.

FIG. 5 shows example configuration interfaces displayed on a subscriber device for obtaining and broadcasting the authentication token and the content privilege information to a content presentation device via an acoustic signal.

FIG. 6 shows an example configuration interface displayed on a content presentation device for configuring the device to receive an acoustic signal that includes the authentication token and the content privilege information.

FIG. 7 is a flow diagram of an example process for the subscriber device to send the acoustic signal that includes the authentication token and the content privilege information to the content presentation device.

FIG. 8 is a flow diagram of an example process for the content presentation device to use the authentication token and the content privilege information obtained from an acoustic signal to access at least one category of content from the content delivery platform.

### DETAILED DESCRIPTION

This disclosure is directed to techniques that enable a subscriber device to use an acoustic signal to transmit an authentication token and content privilege information to a content presentation device. In turn, the authentication token and the content privilege information may be used by the content presentation device to access program content from a content delivery platform. In various embodiments, the subscriber device may be a portable user device, such as a smartphone, a smartwatch, a tablet computer, etc. The content presentation device may be a non-portable large screen smart television set or a smart set-top box that is connected to a non-portable large screen television set. Generally speaking, the content presentation device may be equipped with a larger display screen than the portable user device. The subscriber device may belong to a subscriber that has a subscriber account with the content delivery platform.

In some embodiments, a client application installed on the subscriber device may use radio frequency (RF)-based network communication to authenticate to the content delivery platform. Following authentication, the client application on the subscriber device may request an authentication token and content privilege information for a particular content consumer from the content delivery platform. In turn, the content delivery platform may use RF-based network communication to send the authentication token and the content privilege information to the subscriber device. For example, the content privilege information may indicate one or more categories of program content that the particular content consumer is able to consume from the content delivery platform, whether the particular content consumer is able to purchase additional content, whether the particular content consumer is eligible for one or more promotional offers, and/or so forth.

Upon receiving the authentication token and the content privilege information from the content delivery platform, the client application on the subscriber device may encode the authentication token and the content delivery information into acoustic data. The acoustic data is then converted into an acoustic signal by the subscriber device and broadcasted as sound waves via an audio speaker of the subscriber device. In turn, the acoustic signal may be received by the content presentation device via a built-in microphone. In alternative instances in which the content presentation device lacks a built-in microphone, the content presentation device may receive the acoustic signal via a smart speaker that is connected to the content presentation device.

The acoustic data in the acoustic signal may be decoded by a presentation application of the content presentation device into the authentication token and the content privilege information. The authentication token is then used by the presentation application to authenticate the content presentation device to the content delivery platform. In various embodiments, the presentation application may use RF-based network communication between the content presentation device and the content delivery platform to send the authentication token to the content delivery platform. Following authentication, the presentation application may further use RF-based network communication to transmit the content privilege information to the content delivery platform. The content privilege information is used by the content delivery platform to provide the presentation application on the content presentation device with access to one or more categories of program content.

The techniques may enable a subscriber of the content delivery platform to authenticate the content presentation device as an authorized device to the content delivery platform without having to manually input the login credentials associated with the subscriber account of the subscriber at the content presentation device. For example, the content presentation device may be an unfamiliar device that is only used once or infrequently by the subscriber. As a result, the subscriber may find having to input the login credentials at the device tedious. In some instances, the subscriber may also have concerns regarding security issues associated with inputting the login credentials at the device. In contrast, the techniques may enable the subscriber or a person having permission from the subscriber to access program content from the content delivery platform without inputting the login credentials in these circumstances. The techniques described herein may be implemented in a number of ways. Example implementations are provided below with reference to the following figures.

### Example Architecture

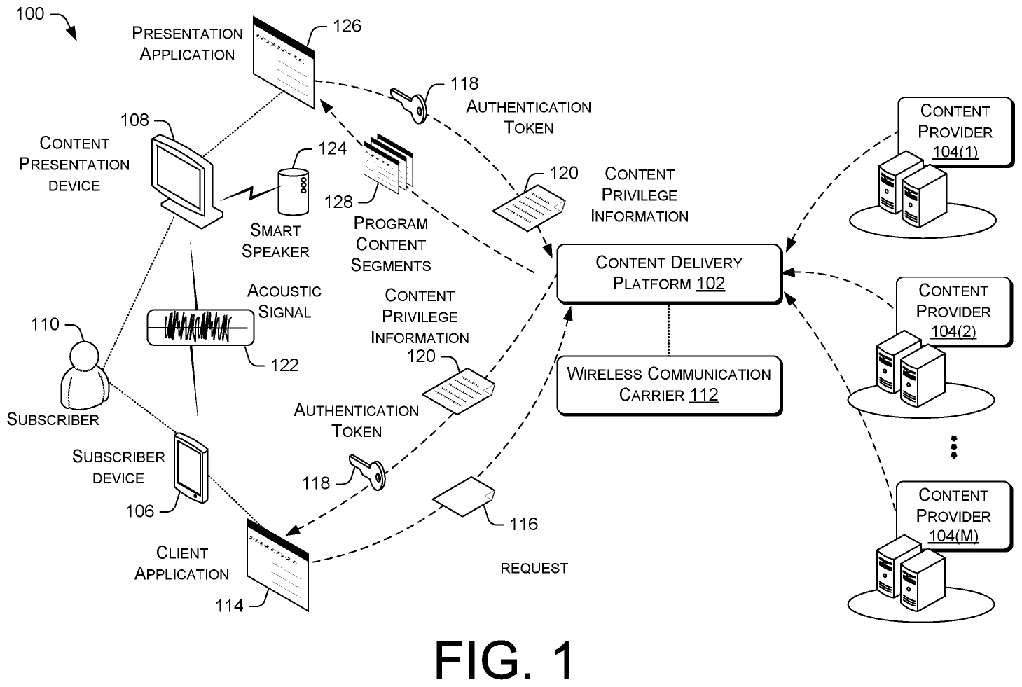

FIG. 1 illustrates an example architecture 100 that uses an acoustic signal to deliver an authentication token to a content presentation device that is able to use the authentication token to access program content from a content delivery platform. The content delivery platform 102 may aggregate content from content providers 104(1)-104(M) for delivery to user devices, such as a subscriber device 106 and a content presentation device 108. In various embodiments, the subscriber device 106 may be a portable user device, such as a smartphone, a smartwatch, a tablet computer, etc., and the content presentation device 108 may be a non-portable large screen smart television set or a smart set-top box that is connected to a non-portable large screen television set. Generally speaking, a non-portable large screen user device may have a larger display screen than the portable user device. The subscriber device 106 may belong to a subscriber, such as the subscriber 110, that has a subscriber account with the content delivery platform.

The content providers 104(1)-104(M) may provide program content segments. The program content segments that are provided by the program content providers may include live content that is delivered in real-time, as well as pre-produced media content that may be streamed on-demand. For example, a program content segment may be in the form of a live show, an episode of a drama, a media work, a broadcast event, and/or so forth. The program content providers may generate revenue by selling broadcast or streaming rights for the program content segments. Alternatively, a program content provider may be commissioned by an operator of the content delivery platform 102 to produce a content program segment. Accordingly, the content delivery platform 102 may pay the program providers for the broadcast or streaming rights to the program content segments. The content delivery platform 102 may collect subscription fees (e.g., monthly fees) from subscribers, such as the subscriber 110, who desire to consume the program content segments. The consumption of a content segment may include viewing the segment, listening to the segment, interacting with the segment, and/or otherwise experiencing the segment in some manner. The content delivery platform 102 may receive the program content segments from the content providers 104(1)-104(M) via a radio frequency (RF)-based communication network. For example, the RF-based communication network may include a local area network (LAN), a larger network such as a wide area network (WAN), or a collection of networks, such as the Internet. Likewise, the subscriber device 106 and the content presentation device 108 may connect to the content delivery platform 102 via the RF-based communication network.

In some instances, the content delivery platform 102 may be affiliated with a wireless communication carrier 112. For example, the content delivery platform 102 may be owned or controlled by the wireless communication carrier 112. The wireless communication carrier 112 may operate a wireless carrier network that provides a wide range of mobile communication services, as well as ancillary services and features, to subscribers and associated mobile device users. The wireless carrier network may be implemented using multiple interconnected networks. In various embodiments, the wireless carrier network may include multiple Radio Access Networks (RANs). The RANs may be connected to each other via regional ground networks. In turn, the regional ground networks may be connected to a core network by a wide area network (WAN). Each regional portion of the wireless carrier network may include one or more RANs and a regional circuit and/or packet-switched network and associated signaling network facilities. The wireless carrier network may provide telecommunication and data communication in accordance with one or more technical standards, such as Enhanced Data Rates for GSM Evolution (EDGE), Wideband Code Division Multiple Access (W-CDMA), High-Speed Packet Access (HSPA), Long Term Evolution (LTE), CDMA-2000 (Code Division Multiple Access 2000), and/or so forth. In some embodiments, the core network of the wireless carrier network may be accessed via wired or wireless LANs. For example, a wireless local area network may be a network that is established using Wi-Fi or Bluetooth standards and hardware. Accordingly, the wireless carrier network, which may be a part of the RF-based communication network, provides telecommunication services to user devices (e.g., the subscriber device 106).

In various embodiments, a client application 114 installed on the subscriber device 106 may use radio frequency (RF)-based network communication to authenticate to the content delivery platform 102. In some embodiments, the client application 114 may be an application that is provided by the content delivery platform 102 or the wireless communication carrier 112. The client application 114 may perform the authentication by sending an authentication request that includes login credentials, so that the login credentials may be validated by the content delivery platform 102. Following validation of the login credentials, the client application 114 may send a request 116 to the content delivery platform 102 for an authentication token 118 and content privilege information 120 for a particular content consumer. For example, the particular content consumer may be the subscriber 110, a family number of the subscriber (e.g., a child, a parent), or some other person associated with the subscriber account of the subscriber 110.

In turn, the content delivery platform 102 may use RF-based network communication to send the authentication token 118 and the content privilege information 120 to the subscriber device 106. For example, the content privilege information includes a consumer identifier of the particular content consumer, and may indicate one or more categories of program content that the particular content consumer is able to consume from the content delivery platform, whether the content consumer is able to purchase additional content, whether the content consumer is eligible for one or more promotional offers, and/or so forth. Accordingly, the content privilege information may in some instances include parental control information indicating one or more categories of program content segments that are viewable by a minor.

Upon receiving the authentication token 118 and the content privilege information 120 from the content delivery platform 102, the client application 114 on the subscriber device 106 may use an encoding algorithm to encode the authentication token 118 and the content privilege information 120 into acoustic data. The acoustic data is then converted into an acoustic signal 122 by the subscriber device 106 and broadcasted as sound waves via an audio speaker of the subscriber device 106. In some instances, the acoustic signal 122 may be a sound signal of a frequency range that is audible to a human ear. In other instances, the acoustic signal 122 may be a sound signal of a frequency range that is inaudible to a human ear. In turn, the acoustic signal 122 may be received by the content presentation device 108 via a built-in microphone. In alternative instances in which the content presentation device 108 lacks a built-in microphone, the acoustic signal 122 may be received by a smart speaker 124 that is connected to the content presentation device. In such instances, the smart speaker 124 may extract the acoustic data from the acoustic signal 122 and send the acoustic data to the content presentation device 108.

The acoustic data in the acoustic signal 122 may be decoded by a presentation application 126 of the content presentation device into the authentication token 118 and the content privilege information 120. The presentation application 126 may be a media application that is configured to download and present program content segments provided by the content delivery platform 102. The authentication token 118 is then used by the presentation application 126 to authenticate the content presentation device 108 to the content delivery platform 102. In various embodiments, the presentation application 126 may use RF-based network communication between the content presentation device 108 and the content delivery platform 102 to send the authentication token 118 to the content delivery platform 102. Following authentication, the presentation application 126 may further use RF-based network communication to transmit the content privilege information 120 to the content delivery platform 102. The content privilege information 120 is used by the content delivery platform 102 to provide the presentation application 126 on the content presentation device 108 with access to one or more categories of program content segments 128.

### Example Subscriber Device Components

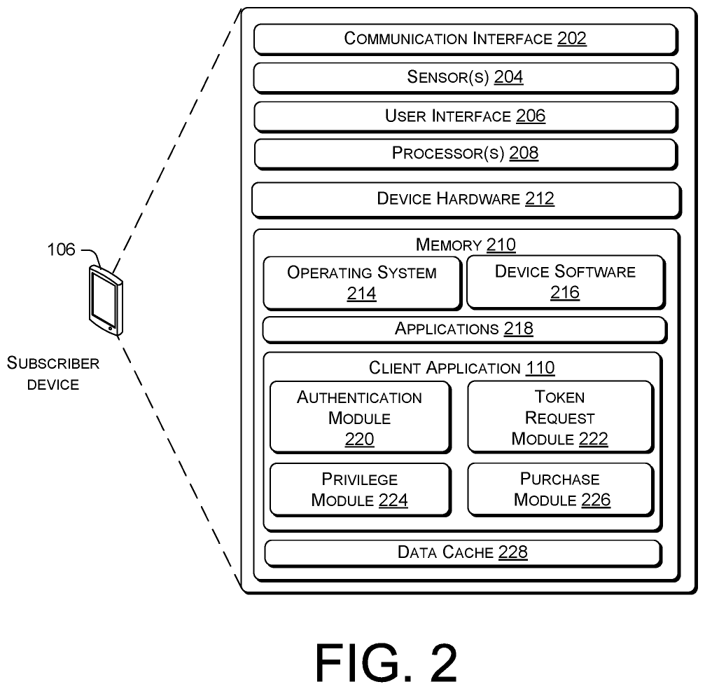

FIG. 2 is a block diagram showing various components of a subscriber device that is configured to deliver the authentication token and content privilege information to the content presentation device via an acoustic signal. The subscriber device 106 may include a communication interface 202, one or more sensors 204, a user interface 206, one or more processors 208, memory 210, and device hardware 212. The communication interface 202 may include wireless and/or wired communication components that enable the electronic device to transmit or receive voice or data communication via the wireless carrier network, as well as other telecommunication and/or data communication networks. The sensors 204 may include a proximity sensor, a compass, an accelerometer, biometric sensors, cameras, and/or a global positioning system (GPS) sensor, among other appropriate sensors. The proximity sensor may detect movement of objects that are proximate to the subscriber device 106. The compass, the accelerometer, and the GPS sensor may detect orientation, movement, and geolocation of the subscriber device 106. The cameras may capture images of the environment around the subscriber device 106.

The user interface 206 may enable a subscriber to provide inputs and receive outputs from the subscriber device 106. The user interface 206 may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

The memory 210 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The device hardware 212 may include a modem that enables the subscriber device 106 to perform telecommunication and data communication with a network. The device hardware 212 may further include signal converters (e.g., a digital-to-analog converter, an analog-to-digital converter), antennas, hardware decoders and encoders, graphics processors, a universal integrated circuit card (UICC) or an embedded UICC (eUICC), and/or the like that enable the subscriber device 106 to execute applications and provide telecommunication and data communication functions.

The one or more processors 208 and the memory 210 of the subscriber device 106 may implement an operating system 214, device software 216, one or more applications 218, and the client application 114. Such software may include routines, program instructions, objects, and/or data structures that are executed by the processors 208 to perform particular tasks or implement particular abstract data types.

The operating system 214 may include components that enable the subscriber device 106 to receive and transmit data via various interfaces (e.g., user controls, communication interface 202, and/or memory input/output devices). The operating system 214 may also process data using the one or more processors 208 to generate outputs based on inputs that are received via the user interface 206. For example, the operating system 214 may provide an execution environment for the execution of the applications 218. The operating system 214 may include a presentation component that presents the output (e.g., display the data on an electronic display, store the data in memory, transmit the data to another electronic device, etc.).

The operating system 214 may include an interface layer that enables applications to interface with the modem and/or the communication interface 202. The interface layer may comprise public APIs, private APIs, or a combination of both public APIs and private APIs. Additionally, the operating system 214 may include other components that perform various other functions generally associated with an operating system. The device software 216 may include software components that enable the user device to perform functions. For example, the device software 216 may include basic input/output system (BIOS), bootrom, or a bootloader that boots up the subscriber device 106 and executes the operating system 214 following power-up of the device.

The applications 218 may include applications that provide utility, entertainment, and/or productivity functionalities to a user of the subscriber device 106. For example, the applications 218 may include telephony applications, electronic mail applications, remote desktop applications, web browser applications, navigation applications, office productivity applications, multimedia streaming applications, an online shopping application, and/or so forth.

The client application 114 may include an authentication module 220, a token request module 222, a privilege module 224, and a purchase module 226. The memory 210 may be further configured to implement a data cache 228. The authentication module 220 may present interface menus that enable a subscriber to create or submit login credentials to establish and access a user account with the content delivery platform 102. The login credentials may include a user identifier, a user password, user biometric data, and/or so forth. In some embodiments, the content delivery platform 102 may share user account information with the wireless communication carrier 112. Accordingly, the user may use the login credentials previously established with the wireless communication carrier 112 to access services provided by the content delivery platform 102.

The token request module 222 may present an interface menu that enables the subscriber to submit a request, such as the request 116, to the content delivery platform 102. The content delivery platform 102 may accept the request following the validation of the login credentials submitted via the authentication module 220. The request may be for an authentication token (e.g., the authentication token 118) and content privilege information (e.g., the content privilege information 120) for a particular content consumer. The authentication token is for authenticating the content presentation device as a device that is under the control of the user. In various embodiments, the interface menu may present a list of consumer identifiers of content consumers that are authorized to consume content using the subscriber account of the subscriber. The consumer identifier may be a login identifier, a name, an email address, or some other identifier that the subscriber previously submitted to the content delivery platform 102. For example, the content consumers may include family members, such as a parent, a child, or some other relative of the subscriber, for whom corresponding content privilege information can be obtained from the content delivery platform 102. Accordingly, the subscriber may select a content consumer from the list of consumer identifiers, and then use an interface control to submit a request to the content delivery platform 102 for the authentication token and the corresponding content privilege information. The subscriber device 106 may use RF-based network communication to send the request to the content delivery platform 102. In turn, the content delivery platform 102 may use RF-based network communication to return an authentication token and the requested content privilege information to the subscriber device 106. The token request module 222 may store the authentication token and the content privilege information in the data cache 228.

Subsequently, the token request module 222 may use the interface menu to notify the subscriber that the subscriber device 106 has received the authentication token and the content privilege information. Furthermore, the interface menu may present the subscriber with an option to broadcast the authentication token and the content privilege information to a nearby content presentation device, such as the content presentation device 108. Following the selection of the option, the token request module 222 may use an acoustic data encoding algorithm to convert the authentication token and the content privilege information into acoustic data. For example, the digital data of the authentication token and the content privilege information may be converted by the algorithm into digitally coded frequency and/or amplitude variations in a carrier wave and stored in the data cache 228 as an audio file. The audio file is then converted by a digital-to-analog converter into an analog acoustic signal (e.g., the acoustic signal 122) that is broadcasted as sound waves via an audio speaker of the subscriber device 106 to a nearby content presentation device. In some implementations, the content presentation device may have a device setup mode that is configured to enable the device to listen for the acoustic signal.

In some embodiments, the interface menu presented by the token request module 222 may include an option to replay the acoustic signal for a predetermined number of times. For each replay of the acoustic signal, the token request module 222 may retrieve the audio file from the data cache 228 and convert the file into the acoustic signal for broadcast. However, once the acoustic signal has been replayed for a predetermined number of times, the token request module 222 may delete the audio file from the data cache 228. However, the token request module 222 may direct the interface menu to present an option for the subscriber to make another request for a new authentication token and content privilege information.

The privilege module 224 may provide one or more interface menus that enable the subscriber to configure the content access privileges for individual content consumers that are authorized to consume content using the subscriber account of the subscriber. In some embodiments, the interface menus may enable the subscriber to select one or more categories of program content that each content consumer is permitted to consume. In some instances, the categories may correspond to specific audience suitability ratings, such as Parental Guidance (PG) ratings promulgated by the Motion Picture Association in the United States (e.g., PG, PG-13, R (Restricted), etc.). In other instances, the categories may correspond to content themes or genres, such as Romance, Comedy, Action, Crime, Horror, War, and/or so forth. In additional instances, the categories may correspond to groups of program content curated by the operator of the content delivery platform 102. For example, the groups may include a group of children program content, a group of teen program content, a group of adult program content, and/or so forth. Accordingly, the subscriber may use the selection settings for parental control of program content viewed by minor content consumers, so as to prevent a minor content consumer from viewing program content in one or more categories that are not age appropriate.

The privilege module 224 may provide additional interface menus that enable the subscriber to customize program purchase privileges for the individual content consumers. For example, the subscriber may use the additional interface menus to configure which content consumer associated with the subscriber account of the subscriber is permitted to purchase program content, the one or more categories of program content each content consumer is permitted to purchase, the payment method for each purchase. For example, some content consumers may be permitted to charge purchases to the subscriber account of the subscriber, while other content consumers may be required to use their own payment method to complete purchases. In other instances, the privilege module 224 may provide interface menus for customizing whether individual content consumers are permitted to receive and accept promotional offers from the content delivery platform 102. For example, a promotional offer may offer discounts or incentives on program content segments provided by the content delivery platform 102. The privilege module 224 may send such content privilege information for the individual content consumers to the content delivery platform 102.

The purchase module 226 may provide a purchase interface to the subscriber so that the subscriber may initiate or renew subscriptions to the program content offered by the content delivery platform 102. For example, the subscription may be a monthly subscription, an annual subscription, or some other periodic subscription. The subscriber may use the purchase interface to input or select a payment method to pay for the periodic subscription to the program content offered by the content delivery platform. For example, the payment method may be a credit card account, a debit card account, a bank account, and/or so forth. In another example, the subscriber may select a billing account that the subscriber established with the wireless communication carrier 112 to pay for the periodic subscription. In some instances, the purchase interface may further enable the subscriber to purchase additional services from the content delivery platform 102. For example, the additional services may include early access to program content, exclusive access to program content, access to high-quality (e.g., 4K resolution program content), and/or so forth.

### Example Content Presentation Device Components

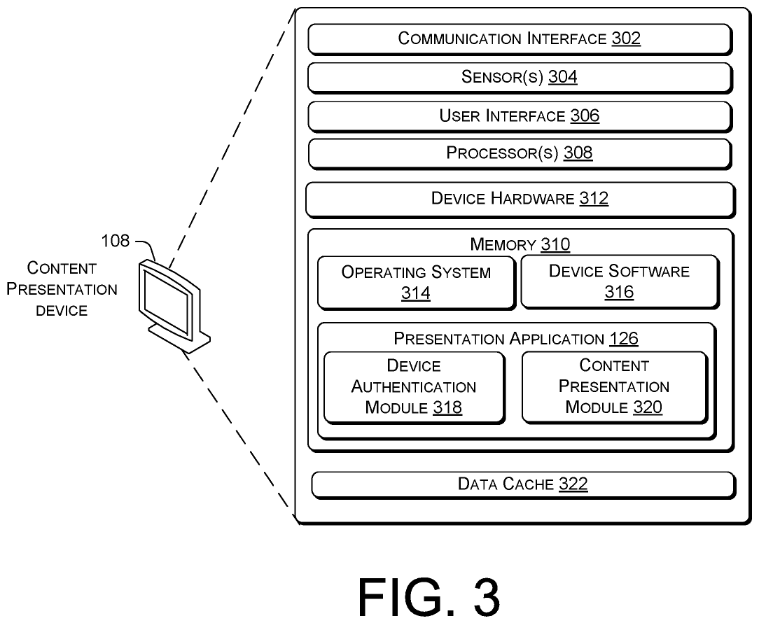

FIG. 3 is a block diagram showing various components of the content presentation device that interfaces with the subscriber device and the content delivery platform. The content presentative device 108 may include a communication interface 302, one or more sensors 304, a user interface 306, one or more processors 308, memory 310, and device hardware 312. The communication interface 302 may include wireless and/or wired communication components that enable the electronic device to transmit or receive voice or data communication via the wireless carrier network, as well as other telecommunication and/or data communication networks. The sensors 304 may include a proximity sensor. The proximity sensor may detect movement of objects that are proximate to the content presentation device 108.

The user interface 306 may enable a subscriber to provide inputs and receive outputs from the content presentation device 108. The user interface 306 may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

The memory 310 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The device hardware 312 may include a network transceiver that enables the subscriber device 106 to perform telecommunication and data communication with a network. The device hardware 312 may further include signal converters (e.g., a digital-to-analog converter, an analog-to-digital converter), antennas, hardware decoders and encoders, graphics processors, and/or the like that enable the subscriber device 106 to execute applications and provide telecommunication and data communication functions.

The operating system 314 may include components that enable the subscriber device 106 to receive and transmit data via various interfaces (e.g., user controls, communication interface 302, and/or memory input/output devices). The operating system 314 may also process data using the one or more processors 308 to generate outputs based on inputs that are received via the user interface 306. For example, the operating system 314 may provide an execution environment for the execution of the presentation application 126. The operating system 314 may include a presentation component that presents the output (e.g., display the data on an electronic display, store the data in memory, transmit the data to another electronic device, etc.).

The operating system 314 may include an interface layer that enables applications to interface with the modem and/or the communication interface 302. The interface layer may comprise public APIs, private APIs, or a combination of both public APIs and private APIs. Additionally, the operating system 314 may include other components that perform various other functions generally associated with an operating system. The device software 316 may include software components that enable the user device to perform functions. For example, the device software 316 may include basic input/output system (BIOS), bootrom, or a bootloader that boots up the presentation application 126 and executes the operating system 314 following power-up of the device. The one or more processors 308 and the memory 310 of the content presentation device 108 may be used to execute the presentation application 126 via the operating system 314. The presentation application 126 may include a device authentication module 318 and a content presentation module 320. The modules may include routines, program instructions, objects, and/or data structures that perform particular tasks or implement particular abstract data types.

The device authentication module 318 may receive acoustic data that includes an authentication token and content privilege information. In some embodiments, the device authentication module 318 may have a device setup mode that places the device authentication module 318 into an active listening state to wait for acoustic data. For example, an interface menu of the device authentication module 318 as presented by the content presentation device 108 may include an option for receiving an authentication token received from a subscriber device. The selection of such an option may place the device authentication module 318 into the active listening state for a predetermined period time. In this way, the device authentication module 318 may use a microphone of the content presentation device 108 to receive an analog acoustic signal that includes the acoustic data. The device authentication module 318 may use an analog-to-digital converter to convert the analog acoustic signal into digital acoustic data. The acoustic data is then decoded by a decoding algorithm into an authentication token and content privilege information. The authentication token is then submitted by the device authentication module 318 along with a device identifier of the content presentation device 108 in a validation request to the content delivery platform 102 via RF-based network communication. In some embodiments, the device authentication module 318 may encrypt the validation request with an encryption key of a symmetric or asymmetric scheme for transmission to the content delivery platform 102.

Thus, if the authentication token is validated, the content delivery platform 102 may establish a communication session with the content presentation device 108. In turn, the device authentication module 318 may direct the content presentation module 320 to submit the content privilege information to the content delivery platform 102 via the communication session in order to access one or more categories of program content from the platform. In some embodiments, the device authentication module 318 may be configured to store the authentication token and the content privilege information in a data cache 322 for a predetermined period of time. In such embodiments, the device authentication module 318 may further retrieve the authentication token and the content privilege information from the data cache 322 for automatic resubmission in a validation request to the content delivery platform 102 upon the occurrence of particular events. For example, the particular events may include a restart of the presentation application 126, a loss of RF-based network connectivity by the content presentation device 108, a recovery from a program error in the presentation application 126, etc.

In other embodiments in which the content presentation device 108 lacks a built-in microphone, the device authentication module 318 may obtain the acoustic data from a smart speaker that is communicatively coupled to the content presentation device 108 via short-range RF-based communication (e.g., Wi-Fi, Bluetooth, etc.). In such embodiments, the device authentication module 318 may have a secondary device setup mode that places the smart speaker into an active listening state to wait for acoustic data. For example, an interface menu of the device authentication module 318 as presented by the content presentation device 108 may include an option for activating a smart speaker to receive an authentication token from a subscriber device. Following the selection of such an option, the device authentication module 318 may command the smart speaker to use its microphone to actively listen for an acoustic signal that is transmitted by a subscriber device for a predetermined period of time. However, in other implementations, the device authentication module 318 may be configured to look for and automatically activate an attached smart speaker to listen for the acoustic data when no built-in microphone of the content presentation device 108 is detected.

In some implementations, the device authentication module 318 may send such a command directly to a command input interface of the smart speaker via short-range RF-based communication. In other implementations, the device authentication module 318 may send the command to a network server that belongs to a third-party controller of the smart speaker via an online command input interface provided by the third-party controller. For example, the device authentication module 318 may send a command request that includes a device identifier of the smart speaker and the command to the network server via RF-based network communication between the content presentation device 108 and the network server. The device identifier may include an Internet Protocol (IP) address, a Media Access Control (MAC) address, and/or so forth. In turn, the network server of the third-party controller may use the device identifier to locate and transmit the command to the smart speaker.

In response to receiving an acoustic signal provided by a subscriber device, the smart speaker may be configured to use an analog-to-digital converter to convert the analog acoustic signal into digital acoustic data. The acoustic data is then sent by the smart speaker to the content presentation device 108 for processing by the device authentication module 318. In some implementations, the smart speaker may transmit the acoustic data to the content presentation device 108 via short-range RF-based communication. In other implementations, the smart speaker may transmit the acoustic data to the network server of the third-party controller for routing to the content presentation device 108 via RF-based network communication. In various embodiments, the acoustic data may be encrypted by the smart speaker via an encryption key of a symmetric or asymmetric scheme for transmission to the content presentation device 108. The encrypted acoustic data is then decrypted by the device authentication module 318 using a counterpart encryption key for decoding by the decoding algorithm.

The content presentation module 320 may submit the content privilege information of a content consumer to the content delivery platform 102 via RF-based network communication. In turn, the content delivery platform 102 may provide the content presentation module 320 with access to one or more categories of program content segments based on the content privilege information. In various embodiments, the content presentation module 320 may populate a content selection interface menu that is shown to the content consumer based on the one or more accessible categories of program content segments. The program content segments may include still images, video files, audio files, multimedia files, etc. In some examples, the available program content segments may be presented as cover flows, in which a content consumer may scroll through a set of icons that represent the program content segments in order to select an item of interest. In other examples, the icons that represented the program content files may be accompanied by navigation controls, such as a slider, a scroll bar, and/or so forth. Such navigation controls may enable the content consumer to browse through the icons to select an item of interest. The selection of an item of interest may trigger the content presentation module 320 to provide information regarding a particular service or a particular media content file.

In various embodiments, the content presentation module 320 may include codecs, decoders, filters, etc. for the presentation, e.g., playback, of different file types. Accordingly, the selection of a program content segment for playback via the selection interface menu may cause the content presentation module 320 to present the program content segment via the user interface 306 of the content presentation device. In some instances, the ability of the content consumer to purchase additional program content segments and/or related services using the selection interface menu may be restricted according to the content privilege information submitted to the content delivery platform 102. For example, the content privilege information may restrict the content consumer to purchases of program content segments that fall within one or more particular categories, place a spending limit on the purchases of program content segments and/or related services, prevent the content consumer from making the purchases, and/or so forth. In other instances, the content presentation module 320 may be directed by the content delivery platform 102 to present promotional offers based on the content privilege information of the content consumer.

### Example Computing Node Components

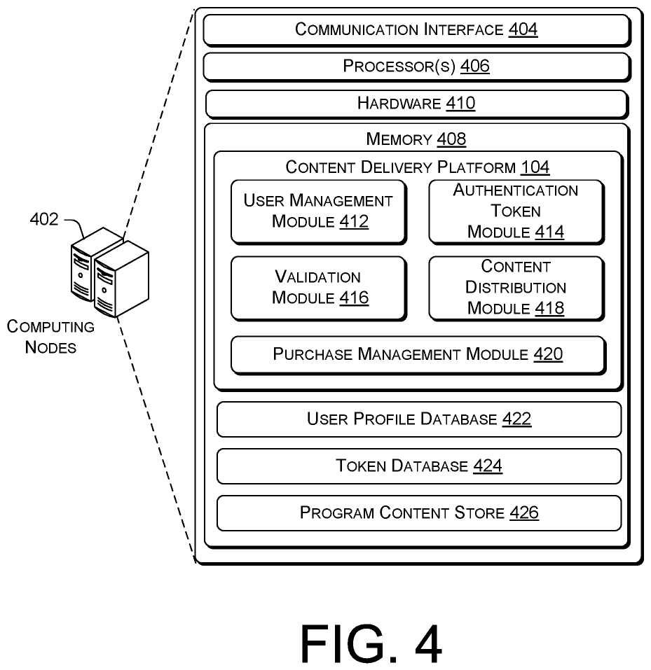

FIG. 4 is a block diagram showing various components of the content presentation device and the content delivery platform that uses the authentication token and the content privilege information encapsulated in the acoustic signal to provide the content presentation device with access to program content. The content delivery platform 102 may be implemented by computing nodes 402. The computing nodes 402 may include a communication interface 404, one or more processors 406, and memory 408. The communication interface 404 may include wireless and/or wired communication components that enable the one or more computing nodes 402 to transmit data to and receive data from other networked devices. The computing nodes 402 may be accessed via hardware 410. The hardware 410 may include additional user interface, data communication, or data storage hardware. For example, the user interface may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 408 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The content delivery platform 102 may be stored in the memory 408 and executed by the one or more processors 406. The content delivery platform 102 may include a user management module 412, an authentication token module 414, a validation module 416, a content distribution module 418, and a purchase management module 420. The modules may include routines, program instructions, objects, and/or data structures that perform particular tasks or implement particular abstract data types.

The user management module 412 may enable subscribers, such as the subscriber 110, to create customer accounts. For example, a subscriber may establish a corresponding customer account by providing registration information to the user management module 412 via a user device, such as the subscriber device 106. The registration information may include a customer name, a customer address, customer contact information, a login identifier, a password, and/or so forth. In some instances, the login identifier may be a subscriber access identifier that is used by the wireless communication carrier 112 to authenticate the subscriber. The registration information may also include the device identifiers of user devices that a subscriber uses to consume content segments. A device identifier of a subscriber device may be a Mobile Station International Subscriber Directory Number (MSISDN), an International Mobile Equipment Identity (IMEI), an International Mobile Subscriber Identity (IMSI), a Mobile Equipment Identifier (MEID) in the form of an Electronic Serial Number (ESN). The subscriber information submitted by the subscriber may further include the consumer identifiers of content consumers that are associated with the subscriber, as well as the access privilege information for each content consumer. The user management module 412 may store such information of each user in a user profile database 422. Each of the customer accounts may also include account access information for one or more financial accounts that a corresponding subscriber provided for paying content service subscriptions and purchase transactions.

The authentication token module 414 may distribute authentication tokens and content privilege information to client applications on subscriber devices. In various embodiments, the authentication token module 414 may receive a request for an authentication token and access privilege information for a particular content consumer from a subscriber device. In turn, the authentication token module 414 may generate an authentication token. For example, the authentication token may include a predetermined number of alphanumeric characters and/or symbols that are randomly or pseudo-randomly generated by the authentication token module 414. Upon the generation of the authentication token, the authentication token module 414 may store a token data entry for the authentication token in a token database 424. The token data entry for an authentication token may store information such as a date and time of the token generation, expiration date and time for the authentication token, the maximum number of times that the authentication token is permitted to be submitted by the same content presentation device, and/or so forth. For example, the default maximum number of permitted times for submission may be preestablished at three times. If applicable, the token data entry for the authentication token may further store a device identifier of the content presentation device that provided the authentication token for validation, the number of times that the authentication token is provided by the content presentation device, and/or so forth. The authentication token module 414 may further use a consumer identifier of the particular content consumer included in the request to retrieve the corresponding content privilege information from the user profile database 422. Subsequently, the authentication token module 414 may send the authentication token and the access privilege information to the subscriber device.

The validation module 416 may validate content presentation devices based on the authentication tokens that are submitted by the content presentation devices. In various embodiments, the validation module 416 may receive a validation request from a content presentation device that includes an authentication token. In some embodiments, the validation request may be first decrypted using a counterpart encryption key that is used by a presentation application to encrypt the validation request. For performing a validation, the authentication token may be examined by the validation module 416 based on the data in a corresponding token data entry in the token database 424. For example, the validation module 416 may determine that the authentication token is valid if the authentication token is not previously submitted by any device for validation and is non-expired. However, if the authentication token was previously submitted for validation, the validation module 416 may determine that the authentication token is valid when the device identifier included in the validation request matches a device identifier of a device that is recorded as having initially submitted the authentication token, the authentication token is non-expired, and the total number of times that the authentication token is submitted does not exceed the maximum number of permitted submissions. Therefore, if the validation module 416 determines that the authentication token is valid, the validation module 416 may use a session management function to establish a communication session with the content presentation device.

The content distribution module 418 may deliver a catalog of one or more available program content segments as well as program content segments to a content presentation device based on the access privilege information submitted via the communication session. In particular, the content distribution module 418 may initially deliver the catalog information and the program content segments to the content presentation device. In some instances, the catalog may include descriptive information for each of the available program content segments, such as cover art, representative pictorial icons, content synopsis, segment duration information, parental guidance rating, and/or so forth. The program content segments are delivered by the content distribution module 418 in response to requests that are initiated at the content presentation device. In some embodiments, the program content segments may be delivered to user devices from a program content store 426 that stores program content segments aggregated from multiple program content providers. In other embodiments, the content distribution module 418 may initiate the streaming of program content segments directly from program content providers to the user devices. The delivery of the content program segments by the content distribution module 418 may be contingent upon the submitted authentication token being non-expired. Thus, the content distribution module 418 may check the corresponding token data entry in the token database 424 prior to delivery each program content segment or any portion of a program content segment.

The purchase management module 420 may be triggered by a purchase request that originates from a subscriber device or a content presentation device. The purchase request may be initiated by a content consumer to purchase services or program content segments provided by the content delivery platform 102. In some instances, the purchase management module 420 may use the access privilege information for the content consumer in the user profile database 422 to determine whether the purchase is authorized. If the purchase is authorized, the purchase management module 420 may charge the purchase to an associated subscriber account. Otherwise, the purchase management module 420 may decline the purchase and notify the subscriber device or the content presentation device that the purchase is not authorized. In turn, the subscriber device or the content presentation device may present the purchase failure to the content consumer.

### Example User Interfaces

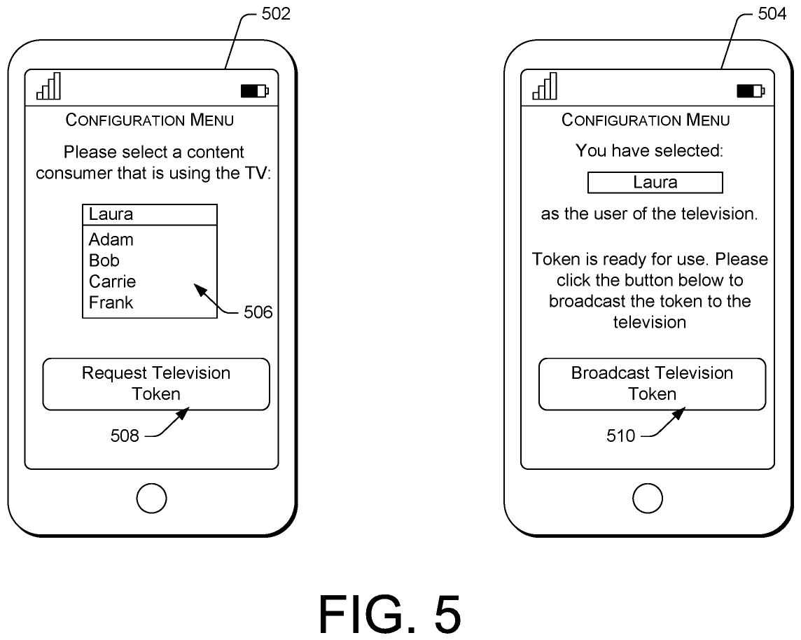

FIG. 5 shows example configuration interfaces displayed on a subscriber device for obtaining and broadcasting an authentication token and content privilege information to a content presentation device via an acoustic signal. The configuration interfaces include a configuration interface 502 and a configuration interface 504. The client application 114 of the subscriber device 106 may display the configuration interface 502 following authentication of the login credentials that are authenticated by the content delivery platform 102. The configuration interface 502 may include a selection interface 506 that enables the selection of a content consumer for whom content privilege information is to be obtained from the content delivery platform 102. The configuration interface 502 may further include an option 508 that is selectable to send a request for an authentication token and content privilege information from the content delivery platform 102.

The configuration interface 504 may be displayed by the client application 114 after the subscriber device 106 obtains the authentication token and the content privilege information from the content delivery platform 102. The configuration interface 504 may include an option 510 that is selectable for triggering the subscriber device 106 to broadcast an acoustic signal that includes the authentication token and the content privilege information.

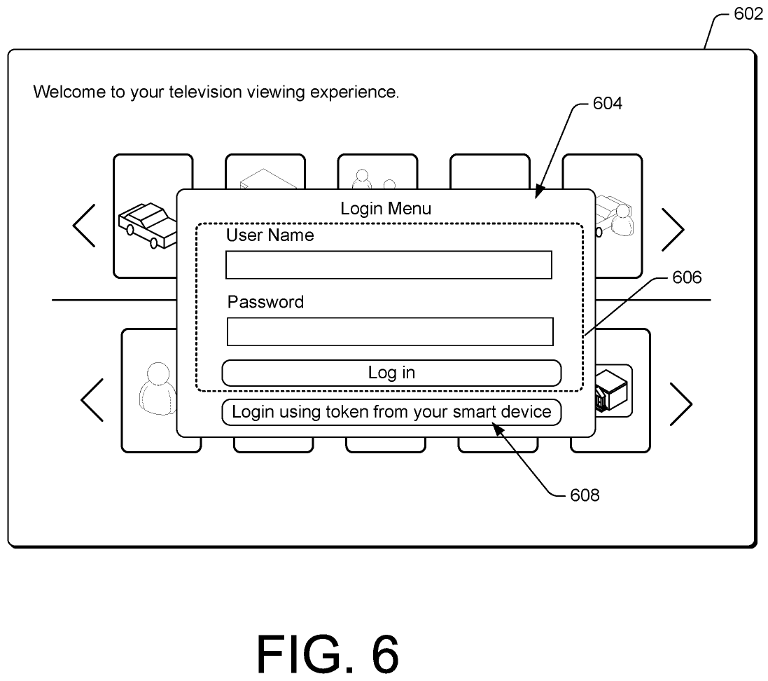

FIG. 6 shows an example configuration interface displayed on a content presentation device for configuring the device to receive an acoustic signal that includes the authentication token and the content privilege information. The configuration interface 602 may be displayed by the presentation application 126 on the content presentation device 108 when a content consumer attempts to access program content segments via the application. The configuration interface 602 may present a login menu 604 that includes a credential input option 606 and a token input option 608. A content consumer may use the credential input option 606 to manually input authentication credentials (e.g., a login name and a password) to authenticate to the content delivery platform 102 and obtain access to the program content segments provided by the platform. Alternatively, the token input option 608 may be selected to put the content presentation device 108 or a smart speaker attached to the device in an active listening mode for an acoustic signal that includes an authentication token and the accompanying content privilege information. The authentication token and the content privilege information are then used by the content presentation device 108 to obtain program content segments from the content delivery platform 102.

### Example Processes

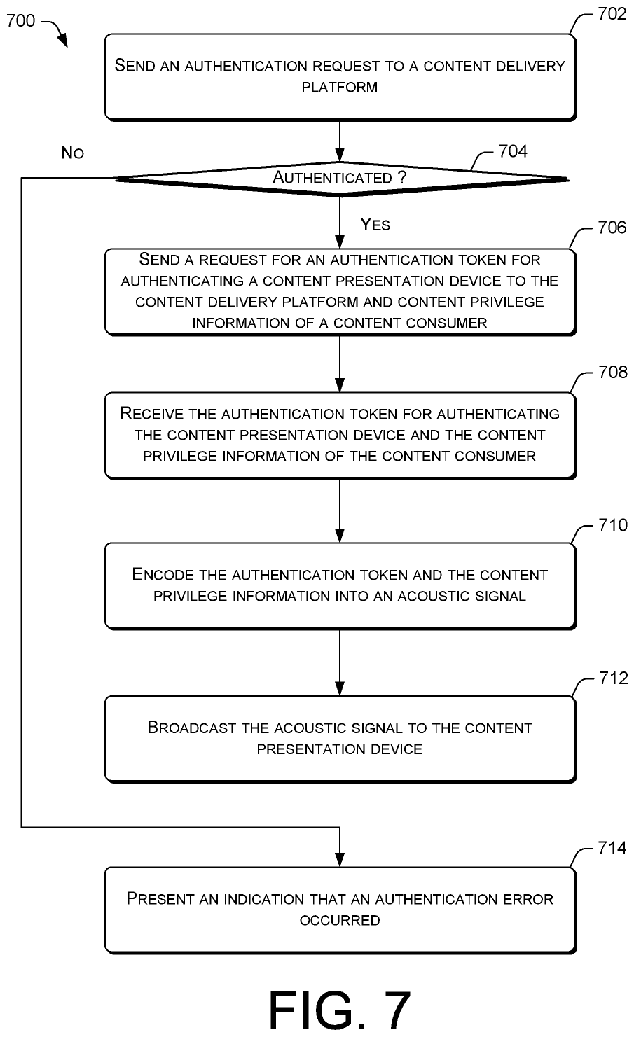

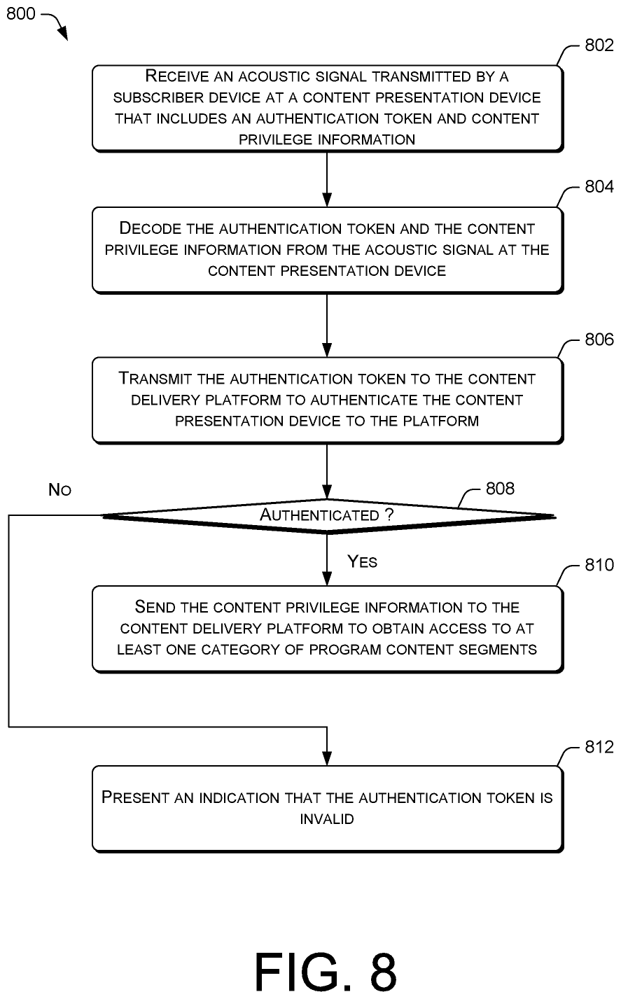

FIGS. 7 and 8 present illustrative processes 700 and 800 for using an acoustic signal to deliver an authentication token to a content presentation device that is able to use the authentication token to access program content from a content delivery platform. Each of the processes 700 and 800 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 700 and 800 are described with reference to the architecture 100 of FIG. 1.

FIG. 7 is a flow diagram of an example process 700 for the subscriber device to send the acoustic signal that includes the authentication token and the content privilege information to the content presentation device. At block 702, the subscriber device 106 may send an authentication request to the content delivery platform 102. In some embodiments, the content delivery platform 102 may be associated with a wireless communication carrier, such as the wireless communication carrier 112. The authentication request may include login credentials, e.g., user identifier, a user password, user biometric data, and/or so forth, for authentication by the content delivery platform 102. The subscriber device 106 may send the authentication request to the content delivery platform 102 via RF-based network communication.

At decision block 704, if the login credentials submitted by the subscriber device 106 in the authentication request are authenticated by the content delivery platform 102, the process may proceed to block 706. In various embodiments, the content delivery platform 102 may send an indication of authentication success or failure to the subscriber device 106 via RF-based network communication.

At block 706, the subscriber device 106 may send a request for an authentication token for authenticating a content presentation device (e.g., the content presentation device 108) to the content delivery platform 102 and content privilege information of a content consumer. In various embodiments, the authentication token may include a predetermined number of randomly or pseudo-randomly generated alphanumeric characters and/or symbols. The authentication token may be configured to expire after a predetermined time period. The content privilege information may indicate one or more categories of program content that the content consumer is able to consume from the content delivery platform, whether the content consumer is able to purchase additional content, whether the content consumer is eligible for one or more promotional offers, and/or so forth. The subscriber device 106 may send the request to the content delivery platform 102 via RF-based network communication.

At block 708, the subscriber device 106 may receive the authentication token for authenticating the content presentation device 108 and the content privilege information of the content consumer. The subscriber device 106 may receive the authentication token and the content privilege information from the content delivery platform 102 via RF-based network communication.

At block 710, the subscriber device 106 may encode the authentication token and the content privilege information into an acoustic signal. In various embodiments, the digital data of the authentication token and the content privilege information may be converted by the subscriber device 106 into acoustic data, and the acoustic data is further converted by a digital-to-analog converter into an acoustic signal.

At block 712, the subscriber device 106 may broadcast the acoustic signal to the content presentation device. The acoustic signal may be transmitted by an audio speaker of the subscriber device 106. In some instances, the acoustic signal may be a sound signal of a frequency range that is audible to a human ear. In other instances, the acoustic signal may be a sound signal of a frequency range that is inaudible to a human ear.

Returning to decision block 704, if the login credentials submitted by the subscriber device 106 in the authentication request are not authenticated by the content delivery platform 102, the process may proceed to block 714. At block 714, the subscriber device 106 may present an indication that an authentication error occurred. The indication may be presented by a user interface of the subscriber device 106.

FIG. 8 is a flow diagram of an example process 800 for the content presentation device to use the authentication token and the content privilege information obtained from an acoustic signal to access at least one category of content from the content delivery platform. At block 802, the content presentation device 108 may receive an acoustic signal transmitted by the subscriber device 106, in which the acoustic signal includes an authentication token and content privilege information. In some instances, the acoustic signal may be received by the content presentation device 108 via a built-in microphone. In alternative instances in which the content presentation device 108 lacks a built-in microphone, the content presentation device 108 may receive the acoustic signal via a smart speaker that is connected to the content presentation device 108.

At block 804, the content presentation device 108 may decode the authentication token and the content privilege from the acoustic signal. In various embodiments, the content presentation device 108 may use an analog-to-digital converter to convert the analog acoustic signal into digital acoustic data. The acoustic data is then decoded by a decoding algorithm of the content presentation device 108 into the authentication token and the content privilege information.

At block 806, the content presentation device 108 may transmit the authentication token to the content delivery platform 102 to authenticate the content presentation device 108 to the platform. In various embodiments, the authentication token may be transmitted to the content delivery platform 102 in a validation request via RF-based network communication.

At decision block 808, if the content presentation device is authenticated by the content delivery platform 102 based on the authentication token, the process 800 may proceed to block 810. For example, the content delivery platform 102 may determine that the authentication token is valid if the authentication token is not previously submitted for validation and is non-expired. However, if the authentication token was previously submitted for validation, the content delivery platform 102 may determine that the authentication token is valid when the device identifier included in the validation request matches a device identifier of a device that is recorded by the content delivery platform 102 as having initially submitted the authentication token, the authentication token is non-expired, and the total number of times that the authentication token is submitted does not exceed the maximum number of permitted submissions.

At block 810, the content presentation device 108 may send the content privilege information to the content delivery platform 102 to obtain access to at least one category of program content segments. In some instances, the categories may correspond to specific audience suitability ratings, such as PG ratings promulgated by the Motion Picture Association in the United States (e.g., PG, PG-13, R, etc.). In other instances, the categories may correspond to content themes or genres, such as Romance, Comedy, Action, Crime, Horror, War, and/or so forth. In additional instances, the categories may correspond to groups of program content curated by the operator of the content delivery platform 102.

Returning to decision block 808, if the content presentation device is not authenticated by the content delivery platform 102 based on the authentication token, the process 800 may proceed to block 812. At block 812, the content presentation device 108 may present an indication that the authentication token is invalid. The indication may be presented by a user interface of the content presentation device 108.

The techniques may enable a subscriber of the content delivery platform to authenticate the content presentation device as an authorized device to the content delivery platform without having to manually input the login credentials associated with the subscriber account of the subscriber at the content presentation device. For example, the content presentation device may be an unfamiliar device that is only used once or infrequently by the subscriber. As a result, the subscriber may find having to input the login credentials at the device tedious. In some instances, the subscriber may also have concerns regarding security issues associated with inputting the login credentials at the device. In contrast, the techniques may enable the subscriber or a person having permission from the subscriber to access program content from the content delivery platform without inputting the login credentials in these circumstances.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computer-implemented method, comprising:
receiving, at a content presentation device, acoustic data in an acoustic signal broadcasted by a subscriber device, the acoustic data including an authentication token that is generated by a content delivery platform for authenticating the content presentation device to the content delivery platform, and content privilege information for a content consumer;
decoding, at the content presentation device, the authentication token and the content privilege information from the acoustic data in the acoustic signal;
transmitting, via the content presentation device, a validation request that includes the authentication token to the content delivery platform to authenticate the content presentation device to the content delivery platform; and
in response to the content presentation device being authenticated by the content delivery platform, transmitting, via the content presentation device, the content privilege information to the content delivery platform to obtain access at the content presentation device to at least one category of multiple categories of program content segments from the content delivery platform.

2. The computer-implemented method of claim 1, wherein the receiving includes receiving the acoustic signal via a microphone of the content presentation device, or receiving the acoustic data from a smart speaker that is communicatively coupled to the content presentation device, the smart speaker capturing the acoustic signal that includes the acoustic data via a microphone of the smart speaker.

3. The computer-implemented method of claim 1, wherein the acoustic data is encoded into the acoustic signal by a client application on the subscriber device, in which the client application requested the authentication token and the content privilege information from the content delivery platform following a successful authentication of login credentials provided by the client application with the content delivery platform.

4. The computer-implemented method of claim 1, wherein the content consumer is a subscriber of the content delivery platform or a person associated with a subscriber account that the subscriber established with the content delivery platform.

5. The computer-implemented method of claim 1, wherein the content privilege information includes parental control information indicating a category of program content segments viewable by a minor, and wherein the transmitting the content privilege information includes transmitting the content privilege information to obtain access to the category of program content segments that is viewable by the minor.

6. The computer-implemented method of claim 1, wherein the content privilege information includes an indication of whether the content consumer is able to purchase additional content or an indication of whether the content consumer is eligible for one or more promotional offers.

7. The computer-implemented method of claim 1, wherein the content presentation device is authenticated by the content delivery platform when the authentication token is not previously submitted by any device for validation and is non-expired.

8. The computer-implemented method of claim 1, wherein the content presentation device is authenticated by the content delivery platform when a device identifier included in the validation request matches a device identifier of a device that is recorded by the content delivery platform as having initially submitted the authentication token, the authentication token is non-expired, and a total number of times that the authentication token is submitted does not exceed a maximum number of permitted submissions.

9. The computer-implemented method of claim 1, wherein the transmitting the validation request or transmitting the content privilege information includes transmitting via radio frequency (RF)-based network communication to the content delivery platform.

10. One or more non-transitory computer-readable media of a subscriber device storing computer-executable instructions that upon execution cause the subscriber device to perform acts comprising:
receiving, from a content delivery platform, an authentication token for authenticating a content presentation device and content privilege information of a content consumer;
encoding the authentication token and the content privilege information into acoustic data for broadcasting as an acoustic signal; and
broadcasting the acoustic signal that includes the authentication token and the content privilege information to the content presentation device, wherein the authentication token and the content privilege information are decoded by the content presentation device from the acoustic data in the acoustic signal, and wherein the authentication token is used by the content presentation device to authenticate to the content delivery platform, and the content privilege information is used by the content present device to access at least one category of multiple categories of content from the content delivery platform.

11. The one or more non-transitory computer-readable media of claim 10, wherein the acoustic data is encoded into the acoustic signal by a client application on the subscriber device, in which the client application requested the authentication token and the content privilege information from the content delivery platform following a successful authentication of login credentials provided by the client application with the content delivery platform.

12. The one or more non-transitory computer-readable media of claim 10, wherein the content consumer is a subscriber of the content delivery platform or a person associated with a subscriber account that the subscriber established with the content delivery platform.

13. The one or more non-transitory computer-readable media of claim 10, wherein the broadcasting includes broadcasting the acoustic signal to a microphone of the content presentation device, or broadcasting the acoustic signal to a smart speaker that is communicatively coupled to the content presentation device.

14. The one or more non-transitory computer-readable media of claim 10, wherein the content privilege information includes parental control information indicating a category of program content segments viewable by a minor.

15. The one or more non-transitory computer-readable media of claim 10, wherein the content privilege information includes an indication of whether the content consumer is able to purchase additional content or an indication of whether the content consumer is eligible for one or more promotional offers.

16. A content presentation device, comprising:
one or more processors; and
memory including a plurality of computer-executable components that are executable by the one or more processors to perform a plurality of actions, the plurality of actions comprising:
receiving acoustic data in an acoustic signal broadcasted by a subscriber device, the acoustic data including an authentication token that is generated by a content delivery platform for authenticating the content presentation device to the content delivery platform, and content privilege information for a content consumer;
decoding the authentication token and the content privilege information from the acoustic data in the acoustic signal;
transmitting a validation request that includes the authentication token to the content delivery platform to authenticate the content presentation device to the content delivery platform; and
in response to the content presentation device being authenticated by the content delivery platform, transmitting the content privilege information to the content delivery platform to obtain access at the content presentation device to at least one category of multiple categories of program content segments from the content delivery platform.

17. The content presentation device of claim 16, wherein the receiving includes receiving the acoustic signal via a microphone of the content presentation device, or receiving the acoustic data from a smart speaker that is communicatively coupled to the content presentation device, the smart speaker capturing the acoustic signal that includes the acoustic data via a microphone of the smart speaker.

18. The content presentation device of claim 16, wherein the content consumer is a subscriber of the content delivery platform or a person associated with a subscriber account that the subscriber established with the content delivery platform.

19. The content presentation device of claim 16, wherein the content privilege information includes parental control information indicating a category of program content segments viewable by a minor, and wherein the transmitting the content privilege information includes transmitting the content privilege information to obtain access to the category of program content segments that is viewable by the minor.

20. The content presentation device of claim 16, wherein the content privilege information includes an indication of whether the content consumer is able to purchase additional content or an indication of whether the content consumer is eligible for one or more promotional offers.
